(19) United States
(12) Patent Application Publication
(10) Pub. No.: US 2012/0207243 A1
(43) Pub. Date: Aug. 16, 2012

(54) Precoder Selection For Precoder Cycling

(75) Inventors: Tommi T. Koivisto, Espoo (FI); Mihai Enescu, Espoo (FI)

(73) Assignee: Renesas Mobile Corporation

(21) Appl. No.: 13/025,509

(22) Filed: Feb. 11, 2011

(51) Int. Cl. H04L 25/49

(52) U.S. Cl. 375/296

(57) ABSTRACT

From a set of X precoding matrix codewords, there is selecting a subset of N codewords so that each selected codeword is optimized for both a cross-polarized antenna array and a co-polarized linear antenna array. Each n^{th} one of the N codewords is associated with a respective n^{th} group of physical resource blocks PRBs which are wirelessly transmitted downlink. N and X are integers, X>N, n indexes through N, and each n^{th} group of PRBs comprises at least one PRB. In various embodiments: each selected codeword is characterized in steering energy in a respective direction are associated with the PRB groups such that no pair of the codewords associated with adjacent ones of the PRB groups steers energy in a same direction; and each of the selected N codewords is formed as a product of two matrices and the selected codewords are cycled among the groups of PRBs.

### TECHNICAL FIELD

The exemplary and non-limiting embodiments of this invention relate generally to wireless communication systems, methods, devices and computer programs and, more specifically, relate to selecting precoders/codewords for downlink MIMO transmissions such as for example in wireless systems without feedback of precoder information in which the downlink transmission scheme must be estimated in the absence of downlink transmission diversity in order to provide channel quality feedback on the uplink.

### BACKGROUND

The following abbreviations that may be found in the specification and/or the drawing figures are defined as follows:
3GPP third generation partnership project
CSI channel state information
CSI-RS channel state information reference symbols
CRS common reference symbols
CQI channel quality indication
DFT discrete Fourier transform
DL downlink
DM-RS demodulation reference symbols
eNB node B/base station in an E-UTRAN system
E-UTRAN evolved UTRAN (LTE)
FSTD frequency-switched transmit diversity
HARQ hybrid automatic repeat request
LTE long term evolution
MIMO multiple input multiple output
PDSCH physical downlink shared channel
PMI precoding matrix indication
PRB physical resource block
RI rank indicator
RS reference signal(s)
RX receive or receiver
SFBC space-frequency block code
TDD time division duplex
TX transmit or transmitter
UE user equipment
UL uplink
ULA uniform linear arrays
UTRAN universal terrestrial radio access network
XP cross-polarized arrays

Some of the changes in LTE Release 10 wireless protocol over previous releases include DL and UL MIMO, enhanced use of relays, bandwidth extensions via carrier aggregation and enhanced inter-cell interference coordination. Relevant to these teachings is DL MIMO; Release 10 supports feedback-based closed-loop spatial multiplexing with up to eight TX antennas (and hence 8×8 MIMO in the context of eight RX antennas) whereas Releases 8/9 supported this for only up to 4 TX antennas. That is, the closed loop precoding for Releases 8 and 9 utilizing a 4 TX antenna codebook has been extended to 8 TX antenna precoding in Release 10. Specifically, in Release 10 there is a special CSI-RS based operation in which the UE computes feedback and sends it to the eNB to support spatial multiplexing. Release 10 defines PMI-based feedback as well as non-PMI—based feedback in which the UE reports only CQI. It follows for those CQI-only reports that since the UL feedback is not PMI-based, the UE must make some assumption about the eNB's transmission scheme on the PDSCH in order to compute CQI.

As an overview, closed-loop spatial multiplexing and multi-user MIMO in the DL for LTE are based on UE feedback, where the UE computes and reports CSI to the eNB in the form of a precoding matrix. LTE Release 8 defines codebooks for two and four TX antennas for feeding back this precoding matrix, and the feedback itself takes the form of an index (termed PMI) of the UE's preferred precoding matrix in the codebook. Release 10 extends this to 8 TX antennas, and defines PMI-based feedback and the codebook for that. In contrast to 2 TX and 4 TX schemes in Releases 8/9, for the 8 TX antenna case in Release 10 the precoding matrices are formed as a product of two matrices. So the final precoders are of the form W=W₁W₂, where W₁ presents the long-term/wideband properties of the radio channel and W₂ captures the short-term/frequency-selective properties of the radio channel. The codebooks are specified in TS 36.211 V10.0.0, section 6.3.4, and in the LTE specifications the double codebook is captured in tables indexed by two indices i1 and i2. Essentially i1 corresponds to the long-term/wideband part whereas i2 corresponds to the short-term/frequency-selective part.

Additionally, transmit diversity may be used as the PDSCH transmission scheme in Release 8/9, in which case the UE only reports CQI on the assumption that the eNB would transmit with SFBC transmit diversity for 2 TX antennas and SFBC-FSTD transmit diversity for 4 TX antennas. The CQI which the UE reports is conditioned on some specific transmission scheme. Release 10 does not support transmit diversity in the case of 8 TX antennas.

In addition to UE-based feedback operation of closed-loop spatial multiplexing, there is the LTE TDD specific operation of non-PMI based closed-loop spatial multiplexing. In this case the UE performs UL sounding in order to estimate the eNB's DL channel. This exploits the radio channel's reciprocity property which is a property specific to TDD. Non-PMI feedback has been defined in both Release 8 (for one stream operation) and Release 9 (for two stream operation). For the non-PMI feedback based operation, inter-cell interference is captured in the CQI report which in Release 9 is derived similarly to transmit diversity. In Release 8 and 9, for CQI computation, the UE is assuming 2 TX SFBC operation on 2 common reference symbols CRS ports, or 4 Tx SFBC-FSTD operation on 4 CRS ports.

While only PMI-based feedback has been specified for Release 10 to date, recent discussions concern PMI feedback disabling, meaning the UE would report only CQI. To compute the CQI the UE needs to know or assume the eNB's DL transmission scheme, which in the transmission diversity examples above for Release 8/9 is termed the PDSCH reference transmission scheme. As in those examples, the UE bases its assumption for the reference transmission scheme on transmit diversity when UE reports only CQI. But for the 8 TX antenna transmissions of Release 10 there is no transmit diversity scheme defined. To ensure correct operation at the UE side when computing the CQI, it should also be possible to transmit with the reference transmission scheme. This would ensure the RAN4 testability of the feature.

One potential solution for the reference transmission scheme is to employ precoder cycling, in which the precoder is changed from PRB to PRB but kept constant within each PRB to allow proper channel estimation for demodulation at the UE side. Precoder cycling is known from Release 8 where it is used for open-loop spatial multiplexing in transmission mode 3 (see 3GPP TS 36.211 V10.0.0, section 6.3.4.2.2).

One specific proposal to utilize precoder cycling in Release 10 is at document R1-110338 by Qualcomm, entitled Remaining details for feedback for TM9 (3GPP TSG-RAN1#63bis meeting; 17-21 Jan. 2011; Dublin, Ireland) which proposes a new feedback mode based on precoder cycling per PRB. In the context of Release 10 8 Tx codebook utilization, for a rank 1 transmission there are 256 final codewords W in total in the codebook; 16 W₁ codewords multiplied by 16 W₂ codewords. The inventors consider this far too many precoders to cycle in a practical system, hence a method is needed for downselecting the codewords to be cycled from the full codebook.

In that same meeting was proposed utilizing a fixed precoder for calculating CQI. The inventors do not consider this as sufficiently reliable. Specifically, the fixed beam would need to be known by both the UE and the eNB. If that could somehow be resolved it appears there would be a high probability that this fixed beam would steer the energy into the wrong direction as compared to the UE signal space, leading to a large number of pessimistic CQI values. It is not anticipated that such high CQI errors can be reasonably corrected with open loop link adaptation techniques which are typically utilized for CQI refinement.

The teachings below address how to enable CQI-only feedback for the 8 TX antenna scheme of Release 10 and particularly a reference transmission scheme from which the UE can compute that CQI. As a reference transmission scheme it is preferable to be specified in wireless standards, but the broader teachings herein are useful also as a standard-transparent transmit diversity scheme for DL transmissions and therefore need not be specified in a written wireless protocol since these broader teachings can be implemented purely within the access node/eNB.

### SUMMARY

In a first exemplary embodiment of the invention there is an apparatus comprising at least one processor and at least one memory storing a computer program. In this embodiment the at least one memory with the computer program is configured with the at least one processor to cause the apparatus to at least: select a subset of N codewords from a set of X precoding matrix codewords, each selected codeword optimized for both a cross-polarized antenna array and a co-polarized linear antenna array; and associate each n^{th} one of the N codewords with a respective n^{th} group of physical resource blocks. In this embodiment, N is an integer greater than one, X is an integer greater than N, n indexes through N, and each n^{th} group of physical resource blocks comprises at least one physical resource block.

In a second exemplary embodiment of the invention there is a method comprising: selecting a subset of N codewords from a set of X precoding matrix codewords, each selected codeword optimized for both a cross-polarized antenna array and a co-polarized linear antenna array; and associating each n^{th} one of the N codewords with a respective n^{th} group of physical resource blocks. In this embodiment, N is an integer greater than one, X is an integer greater than N, n indexes through N, and each n^{th} group of physical resource blocks comprises at least one physical resource block.

In a third exemplary embodiment of the invention there is a computer readable memory storing a computer program, in which the computer program comprises: code for selecting a subset of N codewords from a set of X precoding matrix codewords, each selected codeword optimized for both a cross-polarized antenna array and a co-polarized linear antenna array; and code for associating each n^{th} one of the N codewords with a respective n^{th} group of physical resource blocks. In this embodiment, N is an integer greater than one, X is an integer greater than N, n indexes through N, and each n^{th} group of physical resource blocks comprises at least one physical resource block.

These and other embodiments and aspects are detailed below with particularity.

### BRIEF DESCRIPTION OF THE DRAWINGS

FIG. 1 is a chart showing a set of 8 precoders selected according to an exemplary embodiment of the invention in which adjacent beams are cycled in a consecutive manner.

FIG. 2 is a chart similar to FIG. 1 but with 16 precoders in the selected set.

FIG. 3 is a chart similar to FIG. 1 in which adjacent beams are cycled in a randomized manner for increased diversity in CQI computation.

FIG. 4 is a logic flow diagram that illustrates the operation of a method, and a result of execution of computer program instructions embodied on a computer readable memory, in accordance with the exemplary embodiments of this invention.

FIG. 5 is a simplified block diagram of the UE in communication with a wireless network illustrated as an eNB and a serving gateway SGW, which are exemplary electronic devices suitable for use in practicing the exemplary embodiments of this invention.

### DETAILED DESCRIPTION

Exemplary embodiments of these teachings addresses the assumed PDSCH transmission scheme when computing the CQI in non-PMI—based feedback modes in case of 8 TX antennas at the eNB. As noted above these teachings may also be utilized in standard-transparent demodulation reference signals (DM-RS) based transmit diversity schemes.

To better understand the advantages of these exemplary embodiments for Release 10 deployment, first consider the nature of the Release 10 codebooks. W₁ is essentially a group of 4 TX beams when applied on a 4 TX antenna array, with elements spaced by half of the wavelength. In other words, each beam (which results from the 4 individual antenna weights of the 4 TX antennas) is steering the energy towards a certain physical direction. This structure is particularly appealing for 8 TX cross polarized antennas where there are 4 antenna branches per polarization. W₂ is a set of matrices which selects the optimum beams from W₁ and which uses a co-phasing term to concatenate two 4 TX matrices into a 8 TX precoding matrix. The codebooks are chosen to optimize the precoding performance in typical 8 TX antenna arrays which may be either cross-polarized arrays of 4 TX antennas per polarization, or co-polarized uniform linear arrays of 8 TX antennas (ULA).

Now consider the precoder cycling solution noted in the background section. Since as stated there it is too burdensome to cycle among the 256 final codewords W in total within the codebook (16 W₁ codewords and 16 W₂ codewords), the problem becomes which and how many codewords to select for cycling, and how to select them. The examples below variously show a set of 8 and a set of 16 codewords selected for precoder cycling. In these examples they are selected from the Release 10 codebook, but this is simply for a specific illustration as these teachings are not limited to the CQI only feedback mechanism for 8 TX antennas of Release 10 in specific or to the LTE system in general. They are selected to overcome the problem stated above with the fixed precoder which might steer the beam energy too frequently in the wrong direction.

The Release 10 codebook has been designed to operate for both cross-polarized arrays XP and uniform linear arrays ULA, and so contains codewords for both configurations. But the 8 TX antenna codebook is based on 4 TX beams and also co-phasing terms to combine the 4 TX beams into 8 TX codewords, which the inventors have determined make it particularly advantageous for cross-polarized antenna arrays. Additionally, some of the beam/co-phasing combinations W=W₁W₂ also directly form 8 TX antenna beams, and are therefore particularly useful for co-polarized ULA antenna arrays. There is a well known DFT butterfly technique which is detailed further below and which can be employed in this case to obtain 8 TX DFT vectors (beams) from two 4 TX DFT vectors. Note that this is not true for all possible combinations W=W₁W₂ but only a specific subset of all 8 TX ULA codewords obtained as a combination W=W₁W₂ as is detailed below.

If we consider all the potential precoding matrix codewords as the set X (X=256 in the above example), then the selected subset of N codewords in the below examples is N=8 or N=16 selected codewords, and so X>N since less than all of the X=256 possible codewords are optimized for both cross-polarized arrays XPs and uniform linear arrays ULAs.

Now consider an exemplary but non-limiting technique for how the selection of the optimized codewords may be done, directed specifically to how the 8 TX antenna array codebook for LTE Release 10 is formed. In cross-polarized antenna arrays (XP), the 8 TX array is formed as two 4 TX sub-arrays, each of which uses different polarization. The antennas of each sub-array are in practice typically spaced by half of the wavelength, with wavelength represented by λ as is conventional.

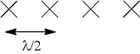

In co-polarized uniform linear antenna arrays (ULA), the 8 TX array is formed simply by having eight antennas, spaced typically in practice by half of the wavelength, each using the same polarization.

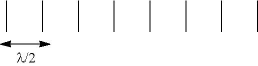

For an antenna array with elements spaced by half of the wavelength λ, an optimum codebook is formed with DFT (Discrete Fourier Transform) vectors. A DFT vector is expressed as

$${v}_{n}^{( M , N )} = \frac{1}{\sqrt{M}} [ \begin{matrix}1 \\ {e}^{i \frac{2 π}{N} \cdot n} \\ {e}^{i \frac{2 π}{N} \cdot 2 n} \\ ⋮ \\ {e}^{i \frac{2 π}{N} \cdot ( M - 1 ) n}\end{matrix} ] ,$$

where M is vector length (4 or 8 in this case), N=QM is the number of beams, Q is the spatial oversampling factor, n is beam (rank-1 codeword) index and i is the imaginary unit. Following this we can write for example DFT-4 vectors (rank-1 codewords) with oversampling factor Q=4 as

$${v}_{n}^{( 4 , 16 )} = \frac{1}{\sqrt{4}} [ \begin{matrix}1 \\ {e}^{i \frac{2 π}{16} \cdot n} \\ {e}^{i \frac{2 π}{16} \cdot 2 n} \\ {e}^{i \frac{2 π}{16} \cdot 3 n}\end{matrix} ] , n = 0 , … , 15.$$

These would constitute optimum rank-1 precoders for each 4-Tx sub-array of the 8 TX cross-polarized antenna array. To get full 8 TX codewords, one needs to have a phase combiner to concatenate two DFT-4 vectors into one 8 TX codeword, and so the final codewords are formed as

$${v}_{n}^{( 8 Tx )} = \frac{1}{√ 2} [ \begin{matrix}{v}_{n}^{( 4 , 16 )} \\ {e}^{iϕ} {v}_{n}^{( 4 , 16 )}\end{matrix} ] ,$$

with the phase factor φ selected from e.g. a QPSK codebook as in LTE Release 10, φε{1, −1, i, −i}.

On the other hand, for 8 TX ULA the optimum codewords are DFT-8 vectors. With oversampling factor Q=2 these vectors are expressed as

$${v}_{n}^{( 8 , 16 )} = \frac{1}{√ 8} [ \begin{matrix}1 \\ {e}^{i \frac{2 π}{16} \cdot n} \\ {e}^{i \frac{2 π}{16} \cdot 2 n} \\ {e}^{i \frac{2 π}{16} \cdot 3 n} \\ {e}^{i \frac{2 π}{16} \cdot 4 n} \\ {e}^{i \frac{2 π}{16} \cdot 5 n} \\ {e}^{i \frac{2 π}{16} \cdot 6 n} \\ {e}^{i \frac{2 π}{16} \cdot 7 n}\end{matrix} ] = \frac{1}{√ 2} [ \begin{matrix}{v}_{n}^{( 4 , 16 )} \\ {e}^{i \frac{2 π}{16} 4 n} {v}_{n}^{( 4 , 16 )}\end{matrix} ] .$$

Comparing the two previous equations, it can be seen that whenever for codeword n the XP combiner phase is selected as

$$ϕ = \frac{2 π}{16} 4 n ,$$

the resulting 8-Tx codeword corresponds to a DFT-8 vector, and hence is optimum for an 8 Tx ULA array (when the antennas are spaced by half of the wavelength).

In other words, the codeword is optimized for both XP and ULA when the combination of beam vₙ^{(4,16)} and phase e^{iφ} is selected such that the resulting codeword matches DFT-8. In this case the codeword corresponding to each 4-TX sub-array is a DFT-4 vector vₙ^{(4,16)}, and the full codeword corresponding to the full 8 Tx array is a DFT-8 vector v(8,16).

Regarding 8 TX double codebook used in LTE Release 10, only well-selected combinations of indices i₁ and i₂ fulfill the above condition, i.e. that the phase is selected such as to make the full 8-TX codeword to be a DFT-8 vector. In an embodiment detailed more particularly below, precoder cycling is done through the precoders that fulfill this condition. Note that the needed phase depends on the beam (DFT vector) index n, hence for different beams a different phase has to be chosen.

In this context, the DFT butterfly technique as mentioned above is a technique for selecting a phase combiner such that two DFT-4 vectors are used to form a DFT-8 vector, as detailed in the above analysis. More generally the DFT butterfly refers to an efficient way of implementing DFTs/FFTs.

In an exemplary embodiment of the invention particular to LTE Release 10 there is selected the precoder indices i1 and i2 such that the resulting precoders that are cycled through correspond exactly to the ones that are optimal for both cross- and co-polarized arrays. Each of the selected codewords are associated with a PRB, or a group of PRBs. For clarity, consider that the eNB disposes each n^{th} selected codeword within a PRB group with which that codeword is associated, and each n^{th} one of the N PRB groups may have one or more than one PRB. Thus for every PRB group there is a pre-defined precoder which is selected from this subset of (i1, i2) index pairs which correspond to the selected codewords, each of which is optimized for both ULA and XP antenna arrays. So long as both the UE and the eNB know in advance what these pairs are, the UE will know the precoders which the eNB will use in each PRB group it transmits and thus the eNB's transmission scheme. Knowing the transmission scheme enables the UE to accurately compute CQI, without having to initially report or suggest a PMI for the eNB to use.

From the optimization analysis above, for the XP case the optimum codeword for each 4-TX subarray is a DFT-4 vector, and for the ULA case the optimum 8-TX codeword is a DFT-8 vector. So a codeword which is optimized for both XP and ULA fulfils both conditions, i.e. that each 4-TX part of the full 8-TX codeword is a DFT-4 vector and that the full 8-TX codeword is a DFT-8 vector. Specifically for the Release 10 LTE double codebook, this is fulfilled in practice by properly selecting correct (i1, i2) codeword combinations.

Conceptually, each beam steers the radiated (transmission) energy towards a certain direction, which may or may not be the correct direction to reach the intended UE. To resolve this issue the precoders are selected and disposed such that the precoder beam direction in consecutive PRB groups are as different as possible. The cycling of precoders therefore randomizes the beam directions. This does not mean that the decision of which precoder to associate with which PRB group is itself a random decision; apart from the first PRB group it is not since precoder directions of adjacent PRB groups should be different. For example, adjacent beams should not be selected to lie in adjacent PRB groups. This aspect of the exemplary embodiments assures that even where the beam energy of one PRB group's precoder points in a direction which the UE cannot easily receive, the beam energy of the precoders in both adjacent PRB groups is likely to be properly received at that same UE. This arrangement should provide maximum diversity.

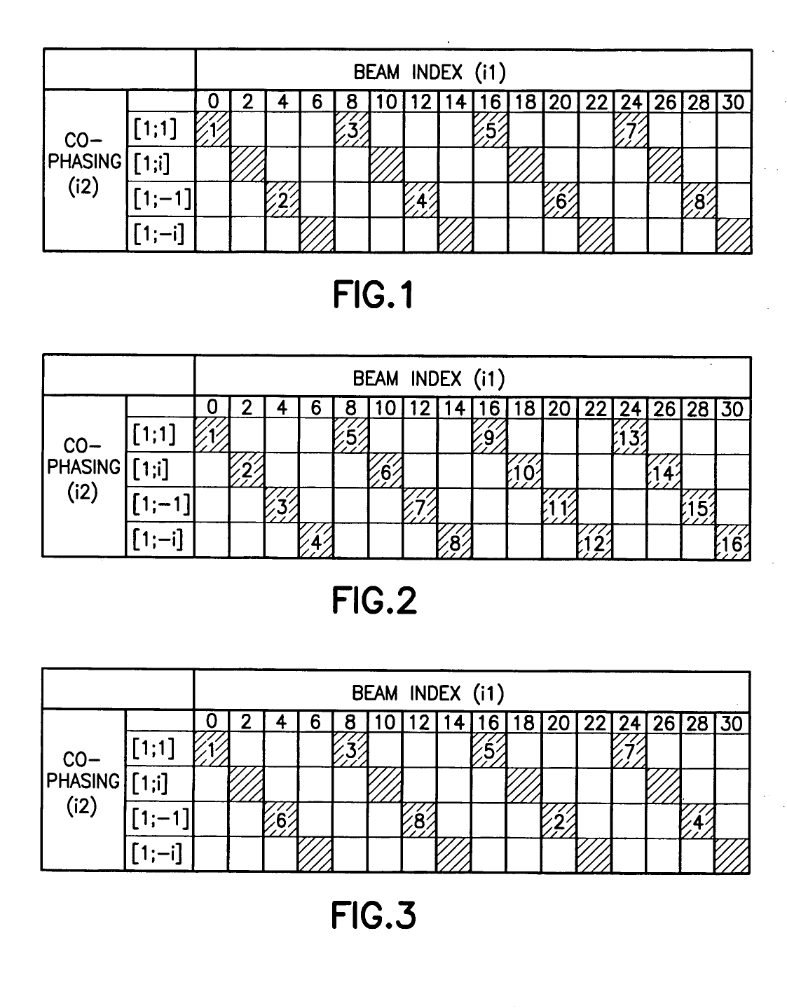

FIGS. 1-3 illustrate specific examples for the 8 TX antenna codebook used in LTE Release 10. Index it selects the beam from the first channel matrix W₁ which represents the long-term/wideband properties of the radio channel, and index i2 selects the co-phasing from the second channel matrix W₂ which represents the short-term/frequency-selective properties of the radio channel. The individual precoders are the product W=W₁W₂ in which W₁ and W₂ are identified by the index pair (i1, i2), and the selected set of precoders according to the embodiments shown in FIGS. 1-3 are indicated by numbering at the shaded intersection of the index pair. Note that any of the shaded intersections lying along the diagonals are appropriate candidates for precoders according to the exemplary embodiments; the selected set of N codewords at FIG. 2 includes all 16 viable precoder candidates whereas the selected sets of N codewords at FIGS. 1 and 3 have only 8 of the total 16 viable precoder candidates. Regardless, each n^{th} codeword selected from the overall set X=256 for the subset of size N is optimized for XP and ULA.

A precoder/codeword is a viable candidate if it is optimal for both cross-polarized and co-polarized arrays, but not all of the viable precoders/codewords need be selected for a given implementation as FIGS. 1 and 3 illustrate. In other embodiments the size and makeup of the underlying matrices W₁ and W₂ may be different than that in Release 10 and so the viable precoder/codeword candidates may be more or fewer than 16, and may or may not line up along diagonals as clearly as in FIGS. 1-3.

In the FIG. 1 example the selected 8 precoders are cycled through in a consecutive manner according to the numbers at the index pair intersection. So for example if we begin with disposing the precoder defined by index pair (0, [1;1]) in PRB_group1, then in the next consecutive PRB_group2 would be disposed the precoder defined by index pair (4, [1;−1]), and the next consecutive PRB_group3 will carry the precoder defined by index pair (8, [1;1]), and so forth.

FIG. 2 is similar to FIG. 1 but all 16 of the precoders which are optimized for both cross-polarized and co-polarized arrays are used for cycling, and the cycling among the precoders is consecutive. So for example the precoder defined by index pair (0, [1;1]) is in PRB_group1, the precoder defined by index pair (2, [1;i]) is in the next consecutive PRB_group2, follows by precoder defined by index pair (4; [1,−1]) in the next consecutive PRB_group3, and so forth.

FIG. 3 shows an example with 8 precoders in the selected set, identical to those at FIG. 1. But at FIG. 3 the precoders and thus the beam directions are cycled through in a randomized way to provide maximum diversity in CQI computation. For FIG. 3 the precoder defined by index pair (0, [1;1]) is put in PRB_group1 (identical to FIG. 1), then in the next consecutive PRB_group2 would be disposed the precoder defined by index pair (20, [1;−1]), the next consecutive PRB_group3 has the precoder defined by index pair (8, [1;1]), followed by PRB_group4 in which is disposed the precoder defined by index pair (28, [1;−1]), and so forth.

Note that for each of FIGS. 1-3, no pair of precoders/codewords which would be placed in adjacent PRB groups is formed by a same co-phasing term from the W₂ matrix.

From the UE perspective, for non-PMI feedback the UE would assume precoding according to the description above, and report CQI for that in the UL. The eNB may then utilize the CQI for transmitting in the DL with the same precoding cycling scheme. Or alternatively the eNB may utilize that CQI for transmitting DL with TDD reciprocity-based beamforming, in which case the eNB may make an adjustment to the CQI reported by the UE to account for the beamforming gain and the number of beams

While the above examples are specific to rank 1 transmissions in LTE Release 10, these teachings are of course equally advantageous for use in higher rank transmissions (open loop spatial multiplexing). For deployment in such higher rank transmission scenarios, in an exemplary embodiment the UE reports rank indicator (RI) in addition to the CQI.

While the above examples are specific to 8Tx double codebook transmissions in LTE Release 10, these teachings are of course equally advantageous for use when different number of antennas, less or greater than 8, are considered while optimization for ULA and XP antennas arrays is desired. The double codebook implementation may be stated more generally in that one matrix which has a co-phasing term to concatenate two Y-transmission antenna matrices into a 2Y-transmission antenna matrix, and the selected set of precoders is then N where N is an integer multiple of 2Y and Y is an integer greater than one.

Exemplary embodiments of these teachings exhibit the technical effect of providing a testable reference transmission scheme for CQI computations in non-PMI —based LTE feedback modes. As compared to fixed precoding, another technical effect of these embodiment is improved performance and utilization beyond CQI calculation purposes for the actual DL (e.g., PDSCH) transmission. For such DL transmissions it is not necessary to stipulate the selected precoder set or the cycling order in a wireless standard/protocol, unlike the CQI reporting functionality for which those parameters should be commonly understood in advance among the UE and eNB.

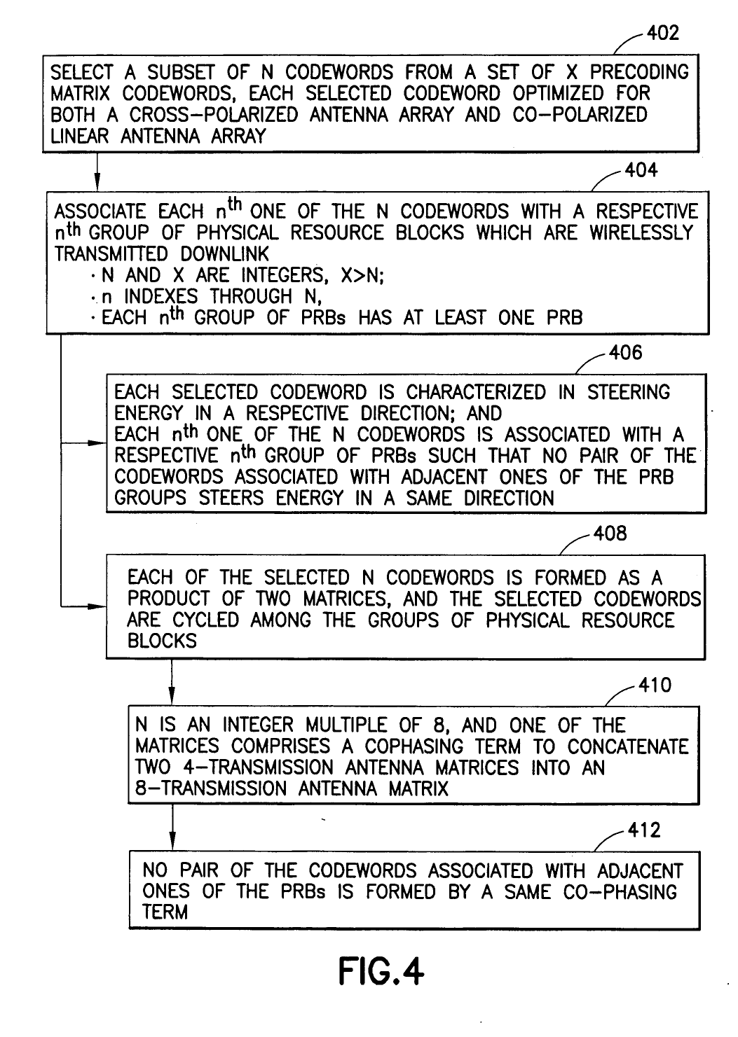

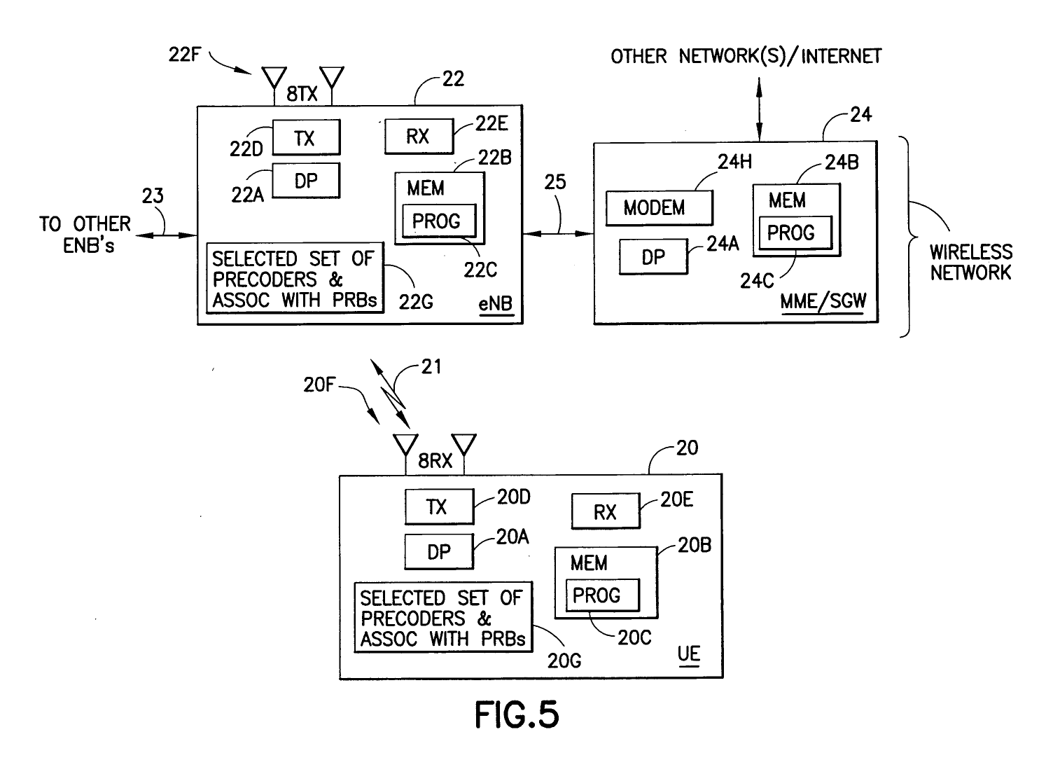

FIG. 4 is a logic flow diagram which describes an exemplary embodiment of the invention in a manner which may be from the perspective of the UE or from the eNB. FIG. 4 may be considered to illustrate the operation of a method, and a result of execution of a computer program stored in a computer readable memory, and a specific manner in which components of an electronic device are configured to cause that electronic device to operate. The various blocks shown in FIG. 4 may also be considered as a plurality of coupled logic circuit elements constructed to carry out the associated function(s), or specific result of strings of computer program code stored in a memory.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

At block 402 there is selected a subset of N codewords from a set of X precoding matrix codewords, each selected codeword optimized for both a cross-polarized antenna array and a co-polarized linear antenna array. At block 404 each n^{th} one of the N codewords is associated with a respective n^{th} group of physical resource blocks. As in the above examples those PRB groups are wirelessly transmitted downlink by the eNB. In this characterization of the exemplary embodiments, N is an integer greater than one, X is an integer greater than N, n indexes through N, and each n^{th} group of physical resource blocks comprises at least one physical resource block. By example, N=8 at FIGS. 1 and 3, and N=16 at FIG. 2. As noted above, each of the selected N codewords is optimized for both a cross-polarized antenna array and a co-polarized linear antenna array, and in the examples for LTE Release 10 each of the selected N codewords is formed as a product of two matrices and the codewords are cycled among the physical resource blocks.

The remainder of FIG. 4 illustrates more specific implementations for blocks 402 and 404. Block 406 recites as detailed above that each selected codeword is characterized in steering energy in a respective direction, and each n^{th} one of the N codewords is associated with a respective n^{th} group of PRBs such that no pair of the codewords associated with adjacent ones of the PRB groups steers energy in a same direction. Block 408 details the cycling for the dual-matrix examples detailed above; each of the selected N codewords is formed as a product of two matrices, and the selected codewords are cycled among the groups of physical resource blocks. At block 410 which is specific for the 8 TX antenna matrix from the above examples, N is an integer multiple of eight, and one of the matrices of block 408 comprises a co-phasing term to concatenate two 4-transmission antenna matrices into an 8-transmission antenna matrix. Block 410 might be stated more generally that the matrices are each Y-transmission antenna matrices, the concatenation results in a 2Y-transmission antenna matrix, and N is an integer multiple of 2Y where Y is itself an integer greater than one. Further detail of block 410 is shown at block 412, in which no pair of the codewords associated with adjacent ones of the physical resource block groups is formed by a same co-phasing term.

For embodiments in which FIG. 4 is from the perspective of a user equipment, such a UE may also include at least one receive antenna and a transmitter. The transmitter is configured to transmit a CQI computed by the UE's processor by utilizing a DL transmission scheme which corresponds to the cycled association of the selected codewords with the respective groups of PRBs.

For embodiments in which FIG. 4 is from the perspective an eNB or more generally a network access node, such an access node further comprising a plurality of transmit antennas and a transmitter, in which the plurality of transmit antennas are configured with the transmitter to transmit the groups of PRBs in which the respective ones of the selected codewords are disposed.

More generally, FIG. 4 may be considered to reflect a modem which may be apart from or disposed in the above UE or eNB.

Reference is now made to FIG. 5 for illustrating a simplified block diagram of various electronic devices and apparatus that are suitable for use in practicing the exemplary embodiments of this invention. In FIG. 5 a wireless network (eNB 22 and mobility management entity MME/serving gateway SGW 24) is adapted for communication over a wireless link 21 with an apparatus, such as a mobile terminal or UE 20, via a network access node, such as a base or relay station or more specifically an eNB 22. The network may include a network control element MME/SGW 24, which provides connectivity with further networks (e.g., a publicly switched telephone network PSTN and/or a data communications network/Internet).

The UE 20 includes processing means such as at least one data processor (DP) 20A, storing means such as at least one computer-readable memory (MEM) 20B storing at least one computer program (PROG) 20C, communicating means such as a transmitter TX 20D and a receiver RX 20E for bidirectional wireless communications with the eNB 22 via one or more antennas 20F (8 RX antennas shown but there may be as few as one RX antenna in certain embodiments). Also stored in the MEM 20B at reference number 20G is an algorithm for selecting the set of precoders and the association with the PRB groups, or for the case such selection may be standardized simply the set of precoders and the PRB or grouped PRB associations as detailed in the examples above.

The eNB 22 also includes processing means such as at least one data processor (DP) 22A, storing means such as at least one computer-readable memory (MEM) 22B storing at least one computer program (PROG) 22C, and communicating means such as a transmitter TX 22D and a receiver RX 22E for bidirectional wireless communications with the UE 20 via one or more antennas 22F (8 TX antennas shown as in the above examples though these teachings may be utilized with 4 or some other number of TX antennas). There is a data and/or control path 25 coupling the eNB 22 with the MME/SGW 24, and another data and/or control path 23 coupling the eNB 22 to other eNBs/access nodes. The eNB 22 stores the algorithm 22G for selecting the set of precoders and the association with the PRB groups, or for the case such selection may be standardized simply the set of precoders and their respective associated PRB or PRB group such as detailed in the examples above.

Similarly, the MME/SGW 24 includes processing means such as at least one data processor (DP) 24A, storing means such as at least one computer-readable memory (MEM) 24B storing at least one computer program (PROG) 24C, and communicating means such as a modem 24H for bidirectional wireless communications with the eNB 22 via the data/control path 25. While not particularly illustrated for the UE 20 or eNB 22, those devices are also assumed to include as part of their wireless communicating means a modem which may be inbuilt on an RF front end chip within those devices 20, 22 and which also carries the TX 20D/22D and the RX 20E/22E.

At least one of the PROGs 20C in the UE 20 is assumed to include program instructions that, when executed by the associated DP 20A, enable the device to operate in accordance with the exemplary embodiments of this invention, as detailed above. The eNB 22 may also have software stored in its MEM 22B to implement certain aspects of these teachings as detailed above. In these regards the exemplary embodiments of this invention may be implemented at least in part by computer software stored on the MEM 20B, 22B which is executable by the DP 20A of the UE 20 and/or by the DP 22A of the eNB 22, or by hardware, or by a combination of tangibly stored software and hardware (and tangibly stored firmware). Electronic devices implementing these aspects of the invention need not be the entire UE 20 or eNB 22, but exemplary embodiments may be implemented by one or more components of same such as the above described tangibly stored software, hardware, firmware and DP, a system on a chip SOC or an application specific integrated circuit ASIC.

In general, the various embodiments of the UE 20 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEMs 20B and 22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A and 22A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the LTE Release 10 system, it should be appreciated that the exemplary embodiments of this invention are not limited for use with only this one particular type of wireless communication system, and that they may be used to advantage in other wireless communication systems such as for example UTRAN, GERAN and GSM and others.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. An apparatus, comprising:
at least one processor; and
at least one memory storing a computer program;
in which the at least one memory with the computer program is configured with the at least one processor to cause the apparatus to at least:
select a subset of N codewords from a set of X precoding matrix codewords, each selected codeword optimized for both a cross-polarized antenna array and a co-polarized linear antenna array; and
associate each n^{th} one of the N codewords with a respective n^{th} group of physical resource blocks;
in which N is an integer greater than one, X is an integer greater than N, n indexes through N, and each n^{th} group of physical resource blocks comprises at least one physical resource block.

2. The apparatus according to claim 1, in which each selected codeword is characterized in steering energy in a respective direction; and
each n^{th} one of the N codewords is associated with its respective n^{th} group of physical resource blocks such that no pair of the codewords associated with adjacent ones of the physical resource block groups steers energy in a same direction.

3. The apparatus according to claim 1, in which each of the selected N codewords is formed as a product of two matrices, and the codewords are cycled among the physical resource blocks.

4. The apparatus according to claim 3, in which N is an integer multiple of 2Y, and one of the matrices comprises a co-phasing term to concatenate the two matrices, each of which is a Y-transmission antenna matrix, into a 2Y-transmission antenna matrix, in which Y is an integer greater than one.

5. The apparatus according to claim 4, in which no pair of the codewords associated with adjacent ones of the physical resource block groups is formed by a same co-phasing term.

6. The apparatus according to claim 5, in which the apparatus comprises a user equipment further comprising at least one receive antenna and a transmitter; in which:
the at least one receive antenna is configured to receive at least some of the selected codewords which are disposed in the respective groups of physical resource blocks; and
the transmitter is configured to transmit a channel quality indicator computed by the at least one processor utilizing a downlink transmission scheme which corresponds to the cycled association of the selected codewords with the respective groups of physical resource blocks.

7. The apparatus according to claim 5, in which the apparatus comprises a network access node further comprising a plurality of transmit antennas and a transmitter; in which the plurality of transmit antennas are configured with the transmitter to transmit the groups of physical resource blocks in which the respective ones of the selected codewords are disposed.

8. The apparatus according to claim 1, in which the apparatus comprises a modem.

9. A method, comprising:
selecting a subset of N codewords from a set of X precoding matrix codewords, each selected codeword optimized for both a cross-polarized antenna array and a co-polarized linear antenna array; and
associating each n^{th} one of the N codewords with a respective n^{th} group of physical resource blocks;
in which N is an integer greater than one, X is an integer greater than N, n indexes through N, and each n^{th} group of physical resource blocks comprises at least one physical resource block.

10. The method according to claim 9, in which each selected codeword is characterized in steering energy in a respective direction; and
each n^{th} one of the N codewords is associated with its respective n^{th} group of physical resource blocks such that no pair of the codewords associated with adjacent ones of the physical resource block groups steers energy in a same direction.

11. The method according to claim 9, in which each of the selected N codewords is formed as a product of two matrices, and the selected codewords are cycled among the groups of physical resource blocks.

12. The method according to claim 11, in which N is an integer multiple of 2Y, and one of the matrices comprises a co-phasing term to concatenate the two matrixes, each of which is a Y-transmission antenna matrix, into a 2Y-transmission antenna matrix, in which Y is an integer greater than one.

13. The method according to claim 12, in which no pair of the codewords associated with adjacent ones of the physical resource block groups is formed by a same co-phasing term.

14. The method according to any claim 13, in which the method is executed by a user equipment and the method further comprises the user equipment:
receiving at least some of the selected codewords which are disposed in the respective groups of physical resource blocks;
computing a channel quality indicator by utilizing a downlink transmission scheme which corresponds to the cycled association of the selected codewords with the respective groups of physical resource blocks; and
transmitting the channel quality indicator.

15. The method according to claim 13, in which the method is executed by a network access node, the method further comprising the network access node transmitting from a plurality of transmit antennas the groups of physical resource blocks in which the respective ones of the selected codewords are disposed.

16. The method according to claim 9, in which the method is executed by a modem.

17. A computer readable memory storing a computer program comprising:
code for selecting a subset of N codewords from a set of X precoding matrix codewords, each selected codeword optimized for both a cross-polarized antenna array and a co-polarized linear antenna array; and
code for associating each n^{th} one of the N codewords with a respective n^{th} group of physical resource blocks;
in which N is an integer greater than one, X is an integer greater than N, n indexes through N, and each n^{th} group of physical resource blocks comprises at least one physical resource block.

18. The computer readable memory according to claim 17, in which each selected codeword is characterized in steering energy in a respective direction; and
the code for associating is for associating each n^{th} one of the N codewords with its respective n^{th} group of physical resource blocks such that no pair of the codewords associated with adjacent ones of the physical resource block groups steers energy in a same direction.

19. The computer readable memory according to claim 18, in which N is an integer multiple of 2Y, each of the selected N codewords is formed as a product of two matrices, and one of the matrices comprises a co-phasing term to concatenate the two matrices, each of which is a Y-transmission antenna matrix, into a 2Y-transmission antenna matrix, where Y is an integer greater than one.

20. The computer readable memory according to claim 19, in which no pair of the codewords associated with adjacent ones of the physical resource block groups is formed by a same co-phasing term.
